(19) United States
(12) Patent Application Publication
(10) Pub. No.: US 2023/0051455 A1
(43) Pub. Date: Feb. 16, 2023

(54) ELECTRIC WIRE PROCESSING DEVICE

(71) Applicant: Yazaki Corporation, Tokyo (JP)

(72) Inventors: Takahito SAITOU, Makinohara-shi (JP); Jun YAGI, Makinohara-shi (JP); Tetsuo IWAO, Susono-shi (JP)

(73) Assignee: Yazaki Corporation, Tokyo (JP)

(21) Appl. No.: 17/884,246

(22) Filed: Aug. 9, 2022

(30) Foreign Application Priority Data
Aug. 10, 2021 (JP) 2021-130720

(51) Int. Cl. H01B 13/00

(52) U.S. Cl. CPC H01B 13/0036

(57) ABSTRACT

An electric wire processing device includes a comb-shaped jig having a plurality of comb teeth; and a drive mechanism configured to, in a state in which at least one electric wire is sandwiched between the plurality of comb teeth, slide the comb-shaped jig on the at least one electric wire.

### CROSS REFERENCE TO RELATED APPLICATIONS

This application is based on and claims priority from Japanese patent application No. 2021-130720 filed on Aug. 10, 2021, the entire contents of which are incorporated herein by reference.

### TECHNICAL FIELD

The present invention relates to an electric wire processing device.

### BACKGROUND ART

When an electric wire wound around a reel is drawn out and processed, the electric wire is fed out while being sandwiched between rollers to straighten winding curl of the electric wire (see, for example, Patent Literature 1). Patent Literature 1 discloses a technique for reducing a pressing force between rollers before and after a position where an electric wire is cut by a cutter part in a method for manufacturing an electric wire in which the electric wire fed out from the reel is sandwiched and straightened by the rollers, and the straightened electric wire is cut to a predetermined length by the cutter part to peel off a coating of an end portion of the electric wire. In the technique of Patent Literature 1, the pressing force is reduced before and after the cutting position of the electric wire, thereby suppressing a displacement (expansion and contraction) of the electric wire and stabilizing a coating position at the end portion of the electric wire.

Patent Literature 1 is JP-A-2017-208174.

However, in the technique of Patent Literature 1, although entanglement and winding curling (a bending peculiarity) of the entire electric wire drawn out from the reel can be straightened, the pressing force between the rollers is reduced at the end portion of the electric wire, and therefore, the technique is not suitable for straightening variation and curling of the end portion of the electric wire. Further, in the technique of Patent Literature 1, in order to straighten the electric wire while feeding the electric wire, a space for arranging a straightening roller or a feeding belt is required.

### SUMMARY OF INVENTION

An electric wire processing device straightens curling of an electric wire in a space-saving manner.

An electric wire processing device includes

a comb-shaped jig having a plurality of comb teeth; and

a drive mechanism configured to, in a state in which at least one electric wire is sandwiched between the plurality of comb teeth, slide the comb-shaped jig on the at least one electric wire.

According to the electric wire processing device of one of embodiments of the present invention, it is possible to straighten the curling of the electric wire in a space-saving manner.

### BRIEF DESCRIPTION OF DRAWINGS

The present invention has been briefly described above. Further, details of the present invention will be clarified by reading a mode (hereinafter, referred to as an “embodiment”) for carrying out the invention to be described below with reference to the accompanying drawings.

FIG. 1 is a view schematically showing a main part of an electric wire processing device according to a first embodiment of the present invention.

FIG. 2 is a diagram showing a state in which a comb-shaped jig shown in FIG. 1 straightens curling of electric wires.

FIG. 3 is a view schematically showing a main part of an electric wire processing device according to a second embodiment of the present invention.

FIG. 4 is a diagram showing a state in which a first comb-shaped jig and a second comb-shaped jig shown in FIG. 3 are closed.

FIG. 5 is a diagram showing the state in which the first comb-shaped jig and the second comb-shaped jig shown in FIG. 3 are closed.

### DESCRIPTION OF EMBODIMENTS

Specific embodiments of the present invention will be described below with reference to the drawings. In the following embodiments, in an electric wire processing device in which end portions of a plurality of electric wires supplied in a state in which ends of the electric wires are aligned are pressed against a connector, an example in which curling of the end portions of the electric wires is straightened by a comb-shaped jig before the electric wires are inserted into the connector will be described.

### First Embodiment

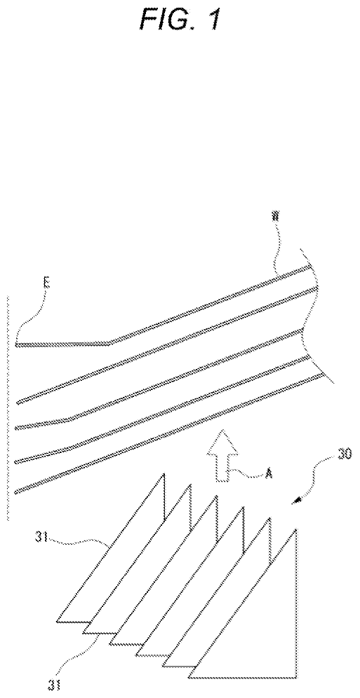

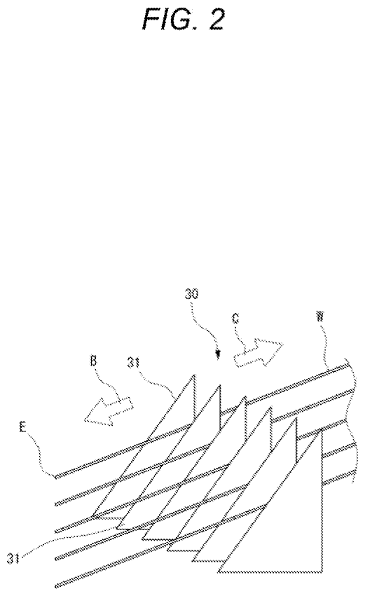

FIG. 1 is a view schematically showing a main part of an electric wire processing device according to a first embodiment of the present invention. FIG. 2 is a diagram showing a state in which a comb-shaped jig 30 shown in FIG. 1 straightens curling of electric wires W. The electric wire processing device measures the electric wires wound around a plurality of reels, cuts the electric wires into a predetermined length, and aligns the cut ends.

FIG. 1 shows a state in which the plurality of electric wires W cut to a predetermined length are arranged in parallel in a state in which electric wire ends E are aligned. Since the plurality of electric wires W have variation and curling at end portions, the plurality of electric wires W may not be correctly inserted into the connector in this state. Therefore, the variation and the curling of the plurality of electric wires W are straightened using the comb-shaped jig 30.

The comb-shaped jig 30 has a plurality of comb teeth 31, and is moved in an upper direction indicated by an arrow A in FIG. 1, and a lower direction, and a front-rear direction along the electric wire W by a drive mechanism (not shown).

The drive mechanism raises the comb-shaped jig 30 from an origin position shown in FIG. 1, and as shown in FIG. 2, moves the comb-shaped jig 30 to a position where each electric wire W is disposed between two adjacent comb teeth 31 and one electric wire W is sandwiched between the two adjacent comb teeth 31. In this state, the comb-shaped jig 30 bites the electric wires W with the plurality of comb teeth 31. Next, the drive mechanism moves the comb-shaped jig 30 in the front-rear direction indicated by arrows B and C in FIG. 2 to slide the comb teeth 31 on the electric wires W. Thereafter, the drive mechanism returns the comb-shaped jig 30 to the original position (see FIG. 1).

In this manner, the comb-shaped jig 30 bites the plurality of electric wires W and slides in the front-rear direction along an extending direction of the electric wires W, so that the variation and the curling of the end portions of the electric wires W are straightened. According to this configuration, the end portion of the electric wire can be intensively straightened, and processing can be performed in a space-saving manner as compared with a case where the electric wire is sandwiched between rollers while being fed to straighten the curling of the electric wire. In addition, the electric wire processing device of the first embodiment can correctly insert the electric wire W in which the variation and the curling of the end portion of the electric wire is straightened by the comb-shaped jig 30, into an electric wire insertion port of the connector.

### Second Embodiment

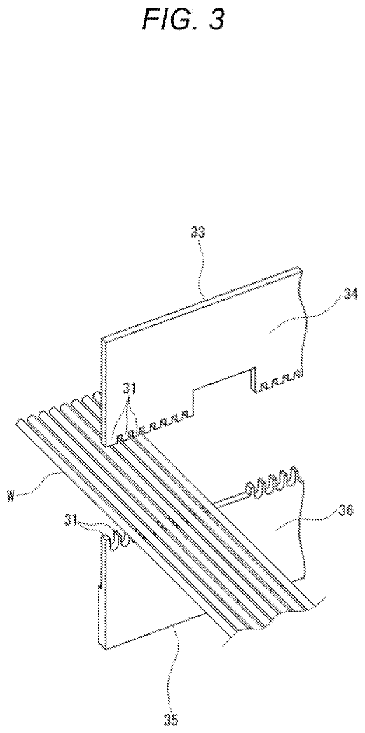

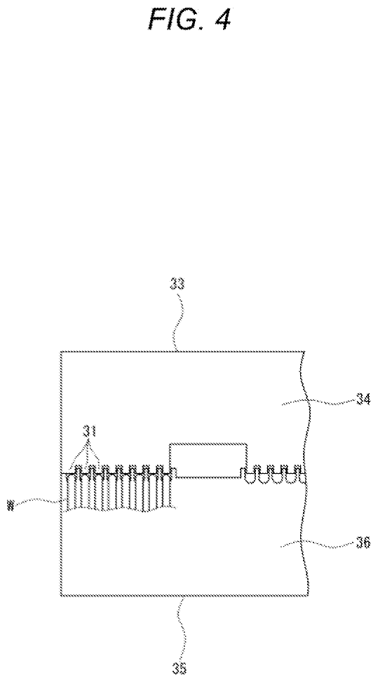

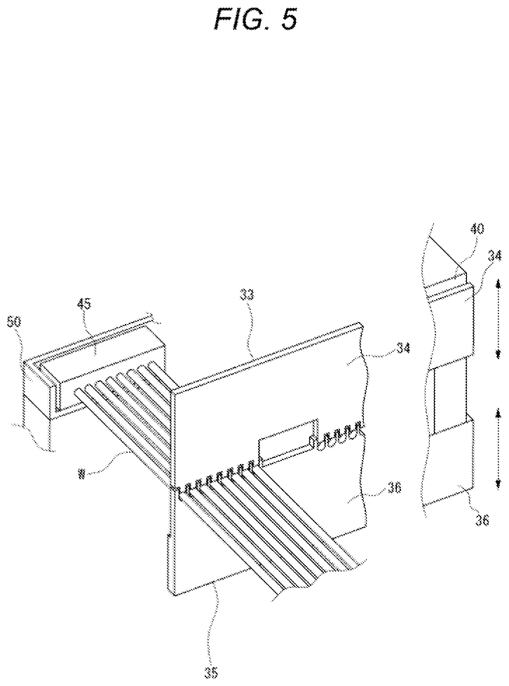

FIG. 3 is a view schematically showing a main part of an electric wire processing device according to a second embodiment of the present invention, and shows a state in which a first comb-shaped jig 33 and a second comb-shaped jig 35 are opened. FIGS. 4 and 5 are diagrams showing a state in which the first comb-shaped jig 33 and the second comb-shaped jig 35 shown in FIG. 3 are closed.

The electric wire processing device of the second embodiment includes the first comb-shaped jig 33 having a plurality of comb teeth (first comb teeth) 31, the second comb-shaped jig 35 having a plurality of comb teeth (second comb teeth) 31, and a drive mechanism 40 that moves the first comb-shaped jig 33 and the second comb-shaped jig 35. The electric wire processing device holds the plurality of electric wires W in a state in which the electric wires W are arranged in parallel.

The first comb-shaped jig 33 and the second comb-shaped jig 35 are respectively disposed on upper and lower sides of the plurality of electric wires W so as to face each other with the plurality of electric wires W arranged in parallel interposed therebetween. As shown in FIG. 5, the first comb-shaped jig 33 and the second comb-shaped jig 35 are disposed on a front side of a connector holding portion 50 that holds a connector 45.

The first comb-shaped jig 33 includes a flat plate portion 34 extending in an arrangement direction of the plurality of electric wires W, that is, a left-right direction in FIG. 4, and the plurality of comb teeth 31 provided at a lower end portion of the flat plate portion 34. The second comb-shaped jig 35 includes a flat plate portion 36 extending in the arrangement direction of the plurality of electric wires W, and the plurality of comb teeth 31 provided at an upper end portion of the flat plate portion 36.

As shown in FIG. 4, the drive mechanism 40 is provided on a side of the first comb-shaped jig 33 and the second comb-shaped jig 35, and drives the flat plate portion 34 of the first comb-shaped jig 33 and the flat plate portion 36 of the second comb-shaped jig 35 in the upper-lower direction by, for example, a cylinder so as to approach and separate from each other. The drive mechanism 40 opens and closes the first comb-shaped jig 33 and the second comb-shaped jig 35 by moving the first comb-shaped jig 33 and the second comb-shaped jig 35 in the upper-lower direction. The drive mechanism 40 causes the first comb-shaped jig 33 and the second comb-shaped jig 35 to approach each other and causes them into a closed state so that the plurality of comb teeth 31 of the first comb-shaped jig 33 and the plurality of comb teeth 31 of the second comb-shaped jig 35 mesh with each other from the state shown in FIG. 3 in which the first comb-shaped jig 33 and the second comb-shaped jig 35 are opened.

In the closed state, each electric wire W is disposed between the two adjacent comb teeth 31 of the first comb-shaped jig 33 and between the corresponding two adjacent comb teeth 31 of the second comb-shaped jig 35. That is, the first comb-shaped jig 33 and the second comb-shaped jig 35 bites the electric wires W by the plurality of comb teeth 31.

The drive mechanism 40 can move the first comb-shaped jig 33 and the second comb-shaped jig 35 in the front-rear direction along the extending direction of the electric wires W. The drive mechanism 40 moves the first comb-shaped jig 33 and the second comb-shaped jig 35, which are in the closed state with the plurality of electric wires W interposed therebetween, in the front-rear direction along the extending direction of the electric wires W to slide the plurality of comb teeth 31 on the plurality of electric wires W. Further, the drive mechanism 40 can cause the first comb-shaped jig 33 and the second comb-shaped jig 35 to approach the connector holding portion 50.

An example of an operation of the drive mechanism 40 will be described. The drive mechanism 40 closes the first comb-shaped jig 33 and the second comb-shaped jig 35 (see FIG. 4) so that the plurality of comb teeth 31 come into contact with portions of the electric wires W at a predetermined position separated from the electric wire ends E by a certain distance, and causes the first comb-shaped jig 33 and the second comb-shaped jig 35 to approach the connector holding portion 50. At this time, the comb teeth 31 slide on the electric wires W to the electric wire ends E. Next, the drive mechanism 40 moves the first comb-shaped jig 33 and the second comb-shaped jig 35 toward the rear of the electric wires W (toward a front side in FIG. 4). At this time, the electric wires W are inserted into the inside from the electric wire insertion ports of the connector 45 while the curling of the end portions of the electric wires is straightened by the first comb-shaped jig 33 and the second comb-shaped jig 35. As described above, the electric wire processing device can insert and connect the electric wires W in which the variation and the curling of the end portions of the electric wires are straightened, to the connector 45 (see FIG. 5). After the insertion of the electric wires W is completed, the drive mechanism 40 returns the first comb-shaped jig 33 and the second comb-shaped jig 35 to the original position (see FIG. 3).

As described above, according to the electric wire processing device of the second embodiment, the first comb-shaped jig 33 and the second comb-shaped jig 35 sandwich the plurality of electric wires W one by one between the comb teeth 31, and the comb teeth 31 slide in the front-rear direction, so that the variation and the curling of the end portions of the electric wires W are straightened. According to this configuration, the end portion of the electric wire can be intensively straightened, and processing can be performed in a space-saving manner as compared with a case where the electric wire is sandwiched between the rollers while being fed to straighten the curling of the electric wire. In addition, the electric wire processing device of the second embodiment can correctly insert the electric wire W in which the variation or the curling of the end portion of the electric wire is straightened by the comb-shaped jig 30, into the electric wire insertion port of the connector 45.

According to the electric wire processing device of the second embodiment, the comb teeth 31 of the first comb-shaped jig 33 and the comb teeth 31 of the second comb-shaped jig 35 slide with respect to one electric wire W in a state in which the comb teeth 31 of the first comb-shaped jig 33 and the comb teeth 31 of the second comb-shaped jig 35 mesh with each other, and thus it is possible to effectively straighten the curling of the electric wire W.

Noted that the present invention is not limited to the embodiments described above, and modifications, improvements, and the like can be made as appropriate.

In addition, materials, shapes, dimensions, numerical values, forms, numbers, arrangement locations, and the like of components in the embodiments described above are optional and are not limited as long as the present invention can be achieved.

For example, in the embodiments described above, the comb teeth 31 are slid on the end portion of the electric wire W, but the comb teeth 31 may be slid on a portion other than the end portion of the electric wire W to straighten the curling of the electric wire W. Further, in the embodiments described above, the electric wire processing device inserts the electric wire W into the connector after straightening the curling of the electric wire W, but the electric wire processing device can perform various processes such as peeling of the end after straightening the electric wire.

Here, characteristics of the electric wire processing device according to the embodiments of the present invention described above will be briefly summarized in the following [1] to [3].

[1] An electric wire processing device including:

a comb-shaped jig (30, the first comb-shaped jig 33, and the second comb-shaped jig 35) having a plurality of comb teeth (31); and

a drive mechanism (40) configured to, in a state in which at least one electric wire is sandwiched between the plurality of comb teeth, slide the comb-shaped jig on the at least one electric wire.

According to the electric wire processing device having the configuration of the above [1], since it is possible to straighten curling of the electric wire by sliding the comb-shaped jig on each of the plurality of electric wires without feeding the electric wire, it is possible to straighten the curling of the electric wire in a space-saving manner as compared with a case where the curling of the electric wire is straightened by sandwiching the electric wire between rollers.

[2] The electric wire processing device according to the above [1],

wherein the drive mechanism (40) causes the comb-shaped jig to slide on the at least one electric wire in a state in which the comb-shaped jig sandwiches an end portion of the at least one electric wire with the plurality of comb teeth.

According to the electric wire processing device having the configuration of the above [2], since it is possible to straighten the curling of the electric wire by sliding the comb-shaped jig on the end portion of each of the plurality of electric wires, it is possible to straighten the variation and the curling of the end portion of the electric wire in a space-saving manner.

[3] The electric wire processing device according to the above [1] or [2],

wherein the comb-shaped jig includes a first comb-shaped jig (33) having a plurality of first comb teeth and a second comb-shaped jig (35) having a plurality of second comb teeth, and

wherein the drive mechanism causes the first comb-shaped jig and the second comb-shaped jig to approach each other so that the plurality of first comb teeth and the plurality of second comb teeth mesh with each other, in a state in which the first comb-shaped jig and the second comb-shaped jig are disposed to face each other with the at least one electric wire interposed therebetween, and slides the first comb-shaped jig and the second comb-shaped jig on the at least one electric wire.

According to the electric wire processing device having the configuration of the above [3], since the first comb teeth of the first comb-shaped jig and the second comb teeth of the second comb-shaped jig slide with respect to one electric wire in a state in which the first comb teeth and the second comb teeth mesh with each other, it is possible to effectively straighten the curling of the electric wire.

What is claimed is:

1. An electric wire processing device comprising:
a comb-shaped jig having a plurality of comb teeth; and
a drive mechanism configured to, in a state in which at least one electric wire is sandwiched between the plurality of comb teeth, slide the comb-shaped jig on the at least one electric wire.

2. The electric wire processing device according to claim 1,
wherein the drive mechanism causes the comb-shaped jig to slide on the at least one electric wire in a state in which the comb-shaped jig sandwiches an end portion of the at least one electric wire with the plurality of comb teeth.

3. The electric wire processing device according to claim 1,
wherein the comb-shaped jig includes a first comb-shaped jig having a plurality of first comb teeth and a second comb-shaped jig having a plurality of second comb teeth, and
wherein the drive mechanism causes the first comb-shaped jig and the second comb-shaped jig to approach each other so that the plurality of first comb teeth and the plurality of second comb teeth mesh with each other, in a state in which the first comb-shaped jig and the second comb-shaped jig are disposed to face each other with the at least one electric wire interposed therebetween, and slides the first comb-shaped jig and the second comb-shaped jig on the at least one electric wire.
